(19) United States
(12) Patent Application Publication
(10) Pub. No.: US 2026/0176484 A1
(43) Pub. Date: Jun. 25, 2026

(54) Radiation-Curable Ink Jet Ink Composition And Recording Device

(71) Applicant: SEIKO EPSON CORPORATION, Tokyo (JP)

(72) Inventors: Midori SEKINE, Matsumoto (JP); Toru SAITO, Yamagata (JP); Masakazu ORII, Matsumoto (JP)

(21) Appl. No.: 19/430,562

(22) Filed: Dec. 23, 2025

(30) Foreign Application Priority Data
Dec. 25, 2024 (JP) 2024-228417

(51) Int. Cl. C09D 11/38; B41J 11/00; B41J 25/00; C09D 11/101; C09D 11/107

(52) U.S. Cl. CPC C09D 11/38; B41J 11/00214; B41J 25/005; C09D 11/101; C09D 11/107

(57) ABSTRACT

A radiation-curable ink jet ink composition includes a hydroxyl group-containing monofunctional monomer and/or an ether cyclic structure-containing monofunctional monomer, a nitrogen-containing heterocyclic structure-containing monofunctional monomer, a bifunctional monomer, and a polymerization initiator, in which the bifunctional monomer includes a vinyl ether group-containing (meth)acrylate represented by Formula (1), a content of the vinyl ether group-containing (meth)acrylate is 20% by mass or greater with respect to a total amount of the ink composition, and the polymerization initiator includes ethyl phenyl(2,4,6-trimethylbenzoyl)phosphinate.

H₂C═CR¹—CO—OR²—O—CH═CH—R³ (1)

The present application is based on, and claims priority from JP Application Serial Number 2024-228417, filed Dec. 25, 2024, the disclosure of which is hereby incorporated by reference herein in its entirety.

### BACKGROUND

### 1. Technical Field

The present disclosure relates to a radiation-curable ink jet ink composition and a recording device.

### 2. Related Art

An ink jet recording method enables recording of a high-definition image with a relatively simple device, and enables rapid development to be achieved in various fields. Under such circumstances, various research is conducted on improvement of various characteristics. For example, JP-A-2021-042321 describes a radiation-curable ink jet ink composition including vinyl methyl oxazolidinone and a vinyl ether group-containing (meth)acrylate having a predetermined structure, with an object of providing a radiation-curable ink jet ink composition that has a low viscosity and can form a coating film with excellent abrasion resistance.

Research is conducted on the ink jet composition described in JP-A-2021-042321 for improving curing properties, flexibility, and the like of a recorded material.

### SUMMARY

According to an aspect of the present disclosure, there is provided a radiation-curable ink jet ink composition of the present disclosure including: a hydroxyl group-containing monofunctional monomer and/or an ether cyclic structure-containing monofunctional monomer; a nitrogen-containing heterocyclic structure-containing monofunctional monomer; a bifunctional monomer; and a polymerization initiator, in which the bifunctional monomer includes a vinyl ether group-containing (meth)acrylate represented by Formula (1), a content of the vinyl ether group-containing (meth)acrylate is 20% by mass or greater with respect to a total amount of the ink composition, and the polymerization initiator includes ethyl phenyl(2,4,6-trimethylbenzoyl)phosphinate.

H₂C═CR¹—CO—OR²O—CH═CH—R³ (1)

(In the formula, R¹ represents a hydrogen atom or a methyl group, R² represents a divalent organic residue having 2 to 20 carbon atoms, and R³ represents a hydrogen or a monovalent organic residue having 1 to 11 carbon atoms.)

A recording device of the present disclosure includes an ink jet head that ejects the radiation-curable ink jet ink composition.

### BRIEF DESCRIPTION OF THE DRAWINGS

FIG. 1 shows an example of a recording device used in the present embodiment.

FIG. 2 is Table 1 listing compositions and evaluation results of radiation-curable ink jet ink compositions used in examples.

FIG. 3 is Table 2 listing compositions and evaluation results of radiation-curable ink jet ink compositions used in examples.

### DESCRIPTION OF EMBODIMENTS

Hereinafter, an embodiment of the present disclosure (hereinafter, referred to as “the present embodiment”) will be described in detail with reference to the accompanying drawings, but the present disclosure is not limited thereto, and various modifications can be made within a range not departing from the scope of the present disclosure.

### 1. Radiation-Curable Ink Jet Ink Composition

A radiation-curable ink jet ink composition of the present embodiment (hereinafter, also referred to as “ink composition”) includes a hydroxyl group-containing monofunctional monomer and/or an ether cyclic structure-containing monofunctional monomer, a nitrogen-containing heterocyclic structure-containing monofunctional monomer, a bifunctional monomer, and a polymerization initiator, in which the bifunctional monomer includes a vinyl ether group-containing (meth)acrylate represented by Formula (1), a content of the vinyl ether group-containing (meth)acrylate is 20% by mass or greater with respect to a total amount of the ink composition, and the polymerization initiator includes ethyl phenyl(2,4,6-trimethylbenzoyl)phosphinate (hereinafter, also referred to as “TPO-L”).

H₂C═CR¹—CO—OR²O—CH═CH—R³ (1)

(In the formula, R¹ represents a hydrogen atom or a methyl group, R² represents a divalent organic residue having 2 to 20 carbon atoms, and R³ represents a hydrogen or a monovalent organic residue having 1 to 11 carbon atoms.)

The curing properties of the ink composition can be improved and the viscosity can be adjusted to be suitable for ejection by using a nitrogen-containing heterocyclic structure-containing monofunctional monomer and a bifunctional monomer of a vinyl ether group-containing (meth)acrylate having a predetermined structure. However, it is found that a coating film becomes hard and brittle when time elapses after formation of the coating film.

Therefore, in the present embodiment, the flexibility of the coating film is intended to be maintained over time by using a hydroxyl group-containing monofunctional monomer or an ether cyclic structure-containing monofunctional monomer in addition to the nitrogen-containing heterocyclic structure-containing monofunctional monomer and a bifunctional monomer of a vinyl ether group-containing (meth)acrylate having a predetermined structure.

In the present embodiment, from the viewpoints of continuous printing stability and the like in the ink jet method, TPO-L in a liquid state at room temperature is used as the polymerization initiator by considering that the hydroxyl group-containing monofunctional monomer or the ether cyclic structure-containing monofunctional monomer has a relatively high viscosity. In this manner, both the maintenance of flexibility over time and the continuous printing stability can be achieved.

The radiation-curable ink jet ink composition of the present embodiment is cured by irradiation with radiation. Examples of the radiation include ultraviolet rays, electron beams, infrared rays, visible light, and X-rays. As the radiation, ultraviolet rays are preferable from the viewpoint that a radiation source is available and widely used and that a material suitable for curing by irradiation with ultraviolet rays is available and widely used.

Hereinafter, each component of the radiation-curable ink jet ink composition of the present embodiment will be described in detail.

### 1.1. Polymerizable Compound

In the present embodiment, compounds that are cured by irradiation with radiation are collectively referred to as polymerizable compounds. Examples of the polymerizable compounds include a monofunctional monomer containing one polymerizable functional group, an oligomer containing one or more polymerizable functional groups, and a polyfunctional monomer containing two or more polymerizable functional groups. In addition, the polyfunctional monomer includes a bifunctional monomer containing two polymerizable functional groups and a tri- or higher polyfunctional monomer containing three or more polymerizable functional groups.

In the present embodiment, the oligomer denotes a multimer containing a polymerizable compound as a constituent component, which is a compound containing one or a plurality of polymerizable functional groups. In the present embodiment, a compound having a molecular weight of 1000 or greater is defined as an oligomer, and a compound having a molecular weight of less than 1000 is defined as a monomer.

### 1.1.1. Monofunctional Monomer

The ink composition of the present embodiment contains a nitrogen-containing heterocyclic structure-containing monofunctional monomer. When the ink composition contains a nitrogen-containing heterocyclic structure-containing monofunctional monomer, the curing properties can be improved and the viscosity can be set in a suitable range. The ink composition of the present embodiment contains a hydroxyl group-containing monofunctional monomer or an ether cyclic structure-containing monofunctional monomer. When the ink composition contains a hydroxyl group-containing monofunctional monomer or an ether cyclic structure-containing monofunctional monomer, the maintainability of flexibility can be improved.

The ink composition of the present embodiment may contain other monofunctional monomers. The other monofunctional monomers are not particularly limited, and examples thereof include a nitrogen-containing monofunctional monomer other than the nitrogen-containing heterocyclic structure-containing monofunctional monomer, an alicyclic group-containing monofunctional monomer, an aliphatic group-containing monofunctional monomer, and an aromatic ring-containing monofunctional monomer. These monofunctional monomers are used alone or in combination of two or more kinds thereof.

The total content of the monofunctional monomer is preferably 30% by mass or greater and 80% by mass or less, more preferably 37% by mass or greater and 70% by mass or less, still more preferably 40% by mass or greater and 60% by mass or less, and particularly preferably 45% by mass or greater and 55% by mass or less with respect to the total amount of the polymerizable compound. When the content of the monofunctional monomer is in the above-described ranges, the curing properties, the abrasion resistance, the maintainability of flexibility, and the continuous printing stability are further improved, and the initial viscosity tends to be in a more suitable range.

The total content of the monofunctional monomer is preferably 20% by mass or greater and 80% by mass or less, more preferably 30% by mass or greater and 608 by mass or less, still more preferably 358 by mass or greater and 50% by mass or less, and particularly preferably 38% by mass or greater and 45% by mass or less with respect to the total amount of the ink composition. When the content of the monofunctional monomer is in the above-described ranges, the curing properties, the abrasion resistance, the maintainability of flexibility, and the continuous printing stability are further improved, and the initial viscosity tends to be in a more suitable range.

### 1.1.1.1. Nitrogen-Containing Heterocyclic Structure-Containing Monofunctional Monomer

The nitrogen-containing heterocyclic structure-containing monofunctional monomer is not particularly limited, but examples thereof include an ε-caprolactam structure-containing monofunctional monomer such as N-vinylcaprolactam, an oxazoline structure-containing monofunctional monomer such as 5-methyl-3-vinyl-oxazolidin-2-one, a morpholine structure-containing monofunctional monomer such as acryloylmorpholine, a carbazole structure-containing monofunctional monomer such as N-vinylcarbazole, and a pyrrolidone structure-containing monofunctional monomer such as N-vinylpyrrolidone. Among these, it is preferable that the ink composition contains one or more selected from the group consisting of an ε-caprolactam structure-containing monofunctional monomer, an oxazoline structure-containing monofunctional monomer, and a morpholine structure-containing monofunctional monomer. When the ink composition contains the above-described compound, the curing properties, the abrasion resistance, and the continuous printing stability are further improved, and the initial viscosity tends to be in a more suitable range.

The content of the nitrogen-containing heterocyclic structure-containing monofunctional monomer is preferably 18 by mass or greater and 30% by mass or less, more preferably 10% by mass or greater and 278 by mass or less, and still more preferably 178 by mass or greater and 23% by mass or less with respect to the total amount of the ink composition. When the content of the nitrogen-containing heterocyclic structure-containing monofunctional monomer is in the above-described ranges, the curing properties, the abrasion resistance, and the continuous printing stability are further improved, and the initial viscosity tends to be in a more suitable range.

### 1.1.1.2. Hydroxyl Group-Containing Monofunctional Monomer

The hydroxyl group-containing monofunctional monomer is not particularly limited, and examples thereof include 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 1,4-cyclohexanedimethanol mono (meth)acrylate, and 2-hydroxy-3-phenoxypropyl acrylate. Among these, 4-hydroxybutyl (meth)acrylate is preferable. When the above-described compound is used, the adhesiveness, the abrasion resistance, the maintainability of flexibility, and the continuous printing stability of the ink coating film are further improved, and the initial viscosity tends to be in a more suitable range.

The content of the hydroxyl group-containing monofunctional monomer is preferably 18 by mass or greater and 30% by mass or less, more preferably 58 by mass or greater and 25% by mass or less, and still more preferably 8% by mass or greater and 15% by mass or less with respect to the total amount of the ink composition. When the content of the hydroxyl group-containing monofunctional monomer is in the above-described ranges, the abrasion resistance, the maintainability of flexibility, and the continuous printing stability are further improved, and the initial viscosity tends to be in a more suitable range.

### 1.1.1.3. Ether Cyclic Structure-Containing Monofunctional Monomer

The ether cyclic structure-containing monofunctional monomer is not particularly limited as long as the monomer has a cyclic ether skeleton such as tetrahydrofuran or tetrahydropyran, and examples thereof include cyclic trimethylolpropane formal (meth)acrylate, tetrahydrofurfuryl (meth)acrylate, and (2-methyl-2-ethyl-1,3-dioxolan-4-yl) methyl acrylate. Among these, cyclic trimethylolpropane formal (meth)acrylate and/or tetrahydrofurfuryl (meth)acrylate is preferably used. When the above-described compound is used, the abrasion resistance, the maintainability of flexibility, and the continuous printing stability are further improved, and the initial viscosity tends to be in a more suitable range.

The content of the ether cyclic structure-containing monofunctional monomer is preferably 18 by mass or greater and 30% by mass or less, more preferably 7% by mass or greater and 25% by mass or less, and still more preferably 12% by mass or greater and 238 by mass or less with respect to the total amount of the ink composition. When the content of the ether cyclic structure-containing monofunctional monomer is in the above-described ranges, the abrasion resistance, the maintainability of flexibility, and the continuous printing stability are further improved, and the initial viscosity tends to be in a more suitable range.

### 1.1.1.4. Alicyclic Group-Containing Monofunctional Monomer

The alicyclic group-containing monofunctional monomer is not particularly limited as long as the monomer has one or more saturated or unsaturated carbon rings with no aromaticity, and examples thereof include a monomer containing a monocyclic hydrocarbon group such as 4-tert-butylcyclohexyl acrylate or 3,3,5-trimethylcyclohexyl acrylate, a monomer containing an unsaturated polycyclic hydrocarbon group such as dicyclopentenyl acrylate or dicyclopentenyl oxyethyl acrylate, and a monomer containing a saturated polycyclic hydrocarbon group such as dicyclopentadienyl acrylate, isobornyl acrylate, or 4-tert-butylcyclohexyl acrylate.

The content of the alicyclic group-containing monofunctional monomer is preferably 18 by mass or greater and 20% by mass or less, more preferably 3% by mass or greater and 17% by mass or less, and still more preferably 7% by mass or greater and 12% by mass or less with respect to the total amount of the ink composition. When the content of the alicyclic group-containing monofunctional monomer is in the above-described ranges, the abrasion resistance, the curing properties, and the continuous printing stability are further improved, and the initial viscosity tends to be in a more suitable range.

### 1.1.1.5. Aromatic Ring-Containing Monofunctional Monomer

It is preferable that the ink composition of the present embodiment contains an aromatic ring-containing monofunctional monomer. When the ink composition contains the above-described compound, the solubility of the acylphosphine-based polymerization initiator tends to be further improved, and the curing properties of the coating film tend to be further improved. The aromatic ring-containing monofunctional monomer is not particularly limited, and examples thereof include phenoxyethyl (meth)acrylate, benzyl (meth)acrylate, alkoxylated 2-phenoxyethyl (meth)acrylate, ethoxylated nonylphenyl (meth)acrylate, alkoxylated nonylphenyl (meth)acrylate, p-cumylphenol EO-modified (meth)acrylate, and 2-hydroxy-3-phenoxypropyl (meth)acrylate.

The content of the aromatic ring-containing monofunctional monomer is preferably 18 by mass or greater and 30% by mass or less, more preferably 38 by mass or greater and 25% by mass or less, still more preferably 6% by mass or greater and 17% by mass or less, and particularly preferably 8% by mass or greater and 15% by mass or less with respect to the total amount of the ink composition. When the content of the aromatic ring group-containing monofunctional monomer is within the above-described ranges, the curing properties, the abrasion resistance, and the continuous printing stability are further improved, and the initial viscosity tends to be in a more suitable range.

### 1.1.2. Polyfunctional Monomer

The total content of the polyfunctional monomer is preferably 20% by mass or greater and 70% by mass or less, more preferably 30% by mass or greater and 65% by mass or less, still more preferably 40% by mass or greater and 60% by mass or less, and particularly preferably 45% by mass or greater and 55% by mass or less with respect to the total amount of the polymerizable compound. When the content of the polyfunctional monomer is in the above-described ranges, the curing properties, the abrasion resistance, the maintainability of flexibility, and the continuous printing stability are further improved, and the initial viscosity tends to be in a more suitable range.

The total content of the polyfunctional monomer is preferably 15% by mass or greater and 60% by mass or less, more preferably 30% by mass or greater and 578 by mass or less, and still more preferably 40% by mass or greater and 50% by mass or less with respect to the total amount of the ink composition. When the content of the polyfunctional monomer is in the above-described ranges, the curing properties, the abrasion resistance, the maintainability of flexibility, and the continuous printing stability are further improved, and the initial viscosity tends to be in a more suitable range.

1.1.2.1. Vinyl Ether Group-Containing (meth)acrylate

The ink composition of the present embodiment contains a vinyl ether group-containing (meth)acrylate represented by Formula (1) (hereinafter, simply referred to as “vinyl ether group-containing (meth)acrylate”). When the ink composition contains the above-described compound, the curing properties are improved, and the initial viscosity can be set to be in a suitable range.

H₂C═CR¹—CO—OR²O—CH═CH—R³ (1)

(In the formula, R¹ represents a hydrogen atom or a methyl group, R² represents a divalent organic residue having 2 to 20 carbon atoms, and R³ represents a hydrogen or a monovalent organic residue having 1 to 11 carbon atoms.)

In Formula (1), the divalent organic residue having 2 to 20 carbon atoms represented by R² is not particularly limited, and examples thereof include a linear, branched, or cyclic alkylene group having 2 to 20 carbon atoms, which may be substituted, an alkylene group having 2 to 20 carbon atoms and an oxygen atom using an ether bond and/or an ester bond in the structure, which may be substituted, and a divalent aromatic group having 6 to 11 carbon atoms, which may be substituted.

In Formula (1), the monovalent organic residue having 1 to 11 carbon atoms represented by R³ is not particularly limited, and examples thereof include a linear, branched, or cyclic alkyl group having 1 to 10 carbon atoms, which may be substituted, and an aromatic group having 6 to 11 carbon atoms, which may be substituted.

The vinyl ether group-containing (meth)acrylate is not particularly limited, and specific examples thereof include 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethylpropyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethylcyclohexylmethyl (meth)acrylate, 3-vinyloxymethylcyclohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(2-vinyloxyethoxy)ethyl (meth)acrylate, 2-(2-vinyloxyethoxy)ethyl acrylate, 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate.

The content of the vinyl ether group-containing (meth)acrylate is 20% by mass or greater, preferably 25% by mass or greater, more preferably 30% by mass or greater, and still more preferably 32% by mass or greater with respect to the total amount of the ink composition. The content of the vinyl ether group-containing (meth)acrylate is preferably 50% by mass or less, more preferably 40% by mass or less, and still more preferably 37% by mass or less with respect to the total amount of the ink composition. When the content of the vinyl ether group-containing (meth)acrylate is in the above-described ranges, the storage stability, the abrasion resistance, the curing properties, and the continuous printing stability are further improved, and the initial viscosity tends to be in a more suitable range.

1.1.2.2. Other Bifunctional (meth)acrylates

The ink composition of the present embodiment may contain other bifunctional monomers, and the other bifunctional monomers are not particularly limited, and examples thereof include a bifunctional (meth)acrylate. The bifunctional (meth)acrylate is not particularly limited, and examples thereof include ethylene glycol di(meth)acrylate, diethylene glycol di(meth)acrylate, triethylene glycol di(meth)acrylate, tetraethylene glycol di(meth)acrylate, tripropylene glycol di(meth)acrylate, 1,4-butanediol di(meth)acrylate, dicyclopentenyl di(meth)acrylate, neopentyl glycol di(meth)acrylate, 1,9-nonanediol di(meth)acrylate, dipropylene glycol di(meth)acrylate, polyethylene glycol di(meth)acrylate, polypropylene glycol di(meth)acrylate, 1,6-hexanediol di(meth)acrylate, and 2-hydroxy-1,3-di(meth)acryloxypropane. Among these, 1,6-hexanediol di(meth)acrylate and/or dipropylene glycol di(meth)acrylate is preferably used. When the above-described compound is used, the abrasion resistance, the curing properties, and the continuous printing stability are further improved, and the initial viscosity tends to be in a more suitable range.

The content of the other bifunctional monomers is preferably 18 by mass or greater and 30% by mass or less, more preferably 3% by mass or greater and 20% by mass or less, and still more preferably 7% by mass or greater and 15% by mass or less with respect to the total amount of the ink composition. When the content of the bifunctional monomers is in the above-described ranges, the abrasion resistance, the curing properties, and the continuous printing stability are further improved, and the initial viscosity tends to be in a more suitable range.

### 1.3. Oligomer

The oligomer is not particularly limited, and examples thereof include a urethane acrylate oligomer having urethane as a repeating structure, a polyester acrylate oligomer having an ester as a repeating structure, and an epoxy acrylate oligomer having epoxy as a repeating structure. Examples of a commercially available product of the urethane acrylate oligomer include CN9893 (trade name, manufactured by Sartomer Company, Inc., aliphatic urethane acrylate oligomer).

The content of the oligomer is preferably 0.1% by mass or greater and 15% by mass or less, more preferably 1% by mass or greater and 10% by mass or less, and still more preferably 2% by mass or greater and 7% by mass or less with respect to the total amount of the ink composition. When the content of the oligomer is in the above-described ranges, the curing properties, the abrasion resistance, and the continuous printing stability are further improved, and the initial viscosity tends to be in a more suitable range.

### 1.2. Polymerization Initiator

The ink composition of the present embodiment contains TPO-L. When TPO-L in a liquid state at room temperature is used, the viscosity can be set to be in a suitable range while the maintainability of flexibility is improved. The ink composition of the present embodiment may contain other polymerization initiators. The other polymerization initiators are not particularly limited as long as the polymerization initiators generate active species by irradiation with radiation, and examples thereof include known polymerization initiators such as an acyl phosphine oxide-based polymerization initiator other than TPO-L, an alkylphenone-based polymerization initiator, a titanocene-based polymerization initiator, and a thioxanthone-based polymerization initiator. These polymerization initiators are used alone or in combination of two or more kinds thereof.

The content of the polymerization initiator is preferably 18 by mass or greater and 20% by mass or less, more preferably 3% by mass or greater and 15% by mass or less, and still more preferably 7% by mass or greater and 12% by mass or less with respect to the total amount of the ink composition. When the content of the polymerization initiator is in the above-described ranges, the abrasion resistance, the curing properties, low-odor properties, and the continuous printing stability are further improved, and the initial viscosity tends to be in a more preferable range.

### 1.2.1. TPO-L

TPO-L is an acyl phosphine oxide-based polymerization initiator and is in a liquid state at room temperature. Examples of a commercially available product of TPO-L include Omnirad TPO-L (trade name, manufactured by IGM Resins B.V.).

The content of ethyl phenyl(2,4,6-trimethylbenzoyl)phosphinate (TPO-L) is preferably 1% by mass or greater and 15% by mass or less, more preferably 5% by mass or greater and 13% by mass or less, and still more preferably 8% by mass or greater and 11% by mass or less with respect to the total amount of the ink composition. When the content of TPO-L is in the above-described ranges, the curing properties, the abrasion resistance, the low-odor properties, and the continuous printing stability are further improved, and the initial viscosity tends to be in a more suitable range.

1.2.2. Acyl Phosphine Oxide-Based Polymerization Initiator other than TPO-L

The acyl phosphine oxide-based polymerization initiator other than TPO-L is not particularly limited, and examples thereof include 2,4,6-trimethylbenzoyldiphenylphosphine oxide, bis(2,4,6-trimethylbenzoyl)-phenylphosphine oxide, and bis(2,6-dimethoxybenzoyl)-2,4,4-trimethylpentylphosphine oxide. Among these, bis(2,4,6-trimethylbenzoyl)phenylphosphine oxide is preferable. When the ink composition contains these compounds, the abrasion resistance, the curing properties, the low-odor properties, and the continuous printing stability are further improved, and the initial viscosity tends to be in a more suitable range.

Examples of a commercially available product of the acyl phosphine oxide-based polymerization initiator include Omnirad 819 (trade name, manufactured by IGM Resins B.V., bis(2,4,6-trimethylbenzoyl)phenylphosphine oxide).

The content of the acyl phosphine oxide-based polymerization initiator other than TPO-L is preferably 1% by mass or greater and 15% by mass or less, more preferably 2% by mass or greater and 10% by mass or less, and still more preferably 38 by mass or greater and 7% by mass or less with respect to the total amount of the ink composition. When the content of the acyl phosphine oxide-based polymerization initiator is in the above-described ranges, the abrasion resistance, the curing properties, the low-odor properties, and the continuous printing stability are further improved, and the initial viscosity tends to be in a more suitable range.

The ink composition in the present embodiment may contain a thioxanthone-based polymerization initiator as a polymerization initiator. The thioxanthone-based polymerization initiator is not particularly limited, and examples thereof include a low-molecular-weight thioxanthone initiator having a molecular weight of less than 500, such as 2,4-diethylthioxanthone or 2-isopropylthioxanthone, and a high-molecular-weight thioxanthone initiator having a molecular weight of 500 or greater, such as polybutylene glycol bis(9-oxo-9H-thioxanthenyloxy)acetate, 1,3-di{α-[1-chloro-9-oxo-9H-thioxanthen-4-yl)oxy]acetylpoly[oxy(1-methylethylene)]}oxy-2,2-bis({α-[1-chloro-9-oxo-9H-thioxanthen-4-yl)oxy]acetylpoly[oxy(1-methylethylene)]}oxymethyl)propane, or α-[2-[(9-oxo-9H-thioxanthenyl)oxy]acetyl]-ω-[[2-[(9-oxo-9H-thioxanthenyl)oxy]acetyl]oxy]poly(oxy-1,4-butanediyl).

### 1.3. Polymerization Inhibitor

The ink composition of the present embodiment may contain a polymerization inhibitor. The polymerization inhibitor is not particularly limited, and examples thereof include a phenol compound, a quinone compound, an amine compound, a nitro compound, an oxime compound, a sulfur compound, and an oxyl compound. These polymerization inhibitors are used alone or in combination of two or more kinds thereof.

The phenol compound is not particularly limited, and examples thereof include p-methoxyphenol, cresol, tert-butylcatechol, di-tert-butylparacresol, hydroquinone monomethyl ether, α-naphthol, 3,5-di-tert-butyl-4-hydroxytoluene, 2,2′-methylenebis(4-methyl-6-tert-butylphenol), 2,2′-methylenebis(4-ethyl-6-butylphenol), and 4,4′-thiobis(3-methyl-6-tert-butylphenol). Examples of a commercially available product of the phenol compound include MEHQ (manufactured by Kanto Chemical Co., Inc., p-methoxyphenol).

The quinone compound is not particularly limited, and examples thereof include p-benzoquinone, anthraquinone, naphthoquinone, phenanthraquinone, p-xyloquinone, p-toluquinone, 2,6-dichloroquinone, 2,5-diphenyl-p-benzoquinone, 2,5-diacetoxy-p-benzoquinone, 2,5-dicaproxy-p-benzoquinone, 2,5-diacyloxy-p-benzoquinone, hydroquinone, 2,5-di-butylhydroquinone, mono-t-butylhydroquinone, monomethylhydroquinone, and 2,5-di-t-amylhydroquinone.

The amine compound is not particularly limited, and examples thereof include phenyl-β-naphthylamine, p-benzylaminophenol, di-β-naphthylparaphenylenediamine, dibenzylhydroxylamine, phenylhydroxylamine, diethylhydroxylamine, a compound having a 2,2,6,6-tetramethylpiperidine skeleton, a compound having a 2,2,6,6-tetramethylpiperidine-N-alkyl skeleton, and a compound having a 2,2,6,6-tetramethylpiperidine-N-acyl skeleton.

The nitro compound is not particularly limited, and examples thereof include dinitrobenzene, trinitrotoluene, picric acid, and derivatives thereof. The oxime compound is not particularly limited, and examples thereof include quinone dioxime and cyclohexanone oxime. The sulfur compound is not particularly limited, and examples thereof include phenothiazine.

The oxyl compound is not particularly limited, and examples thereof include derivatives of 2,2,6,6-tetramethylpiperidinyl-1-oxyl. Examples of the derivatives of 2,2,6,6-tetramethylpiperidinyl-1-oxyl include 4-acetamido-2,2,6,6-tetramethylpiperidinyl-1-oxyl, 4-amino-2,2,6,6-tetramethylpiperidinyl-1-oxyl, 4-carboxy-2,2,6,6-tetramethylpiperidinyl-1-oxyl, 4-(2-chloroacetamido)-2,2,6,6-tetramethylpiperidinyl-1-oxyl, 4-cyano-2,2,6,6-tetramethylpiperidinyl-1-oxyl, 4-hydroxy-2,2,6,6-tetramethylpiperidinyl-1-oxyl, 4-hydroxybenzoate-2,2,6,6-tetramethylpiperidinyl-1-oxyl, 4-(2-iodoacetamido)-2,2,6,6-tetramethylpiperidinyl-1-oxyl, 4-isothiocyanate-2,2,6,6-tetramethylpiperidinyl-1-oxyl, 4-methacryloyloxy-2,2,6,6-tetramethylpiperidinyl-1-oxyl, 4-methoxy-2,2,6,6-tetramethylpiperidinyl-1-oxyl, 4-oxo-2,2,6,6-tetramethylpiperidinyl-1-oxyl, and 4-(2-propylinyloxy)-2,2,6,6-tetramethylpiperidinyl-1-oxyl. Examples of a commercially available product of the oxyl compound include ADK STAB LA-7RD (trade name, manufactured by ADEKA Corporation, 4-hydroxy-2,2,6,6-tetramethylpiperidinyl-1-oxyl).

The content of the polymerization inhibitor is preferably 0.01% by mass or greater and 5.0% by mass or less, more preferably 0.05% by mass or greater and 3.0% by mass or less, and still more preferably 0.1% by mass or greater and 1.0% by mass or less with respect to the total amount of the ink composition. When the content of the polymerization inhibitor is in the above-described ranges, the abrasion resistance, the curing properties, the maintainability of flexibility, the low-odor properties, and the continuous printing stability tend to be further improved.

### 1.4. Surfactant

The ink composition of the present embodiment may contain a surfactant. Examples of the surfactant include an acetylene glycol-based surfactant, a fluorine-based surfactant, and a silicone-based surfactant. These surfactants are used alone or in combination of two or more kinds thereof.

The acetylene glycol-based surfactant is not particularly limited, and examples thereof include alkylene oxide adducts of 2,4,7,9-tetramethyl-5-decyne-4,7-diol and 2,4,7,9-tetramethyl-5-decyne-4,7-diol. Examples of a commercially available product of the acetylene glycol-based surfactant include SURFYNOL 465 (trade name, manufactured by Nisshin Chemical Co., Ltd.).

The fluorine-based surfactant is not particularly limited, and examples thereof include a perfluoroalkyl sulfonate, a perfluoroalkyl carboxylate, a perfluoroalkyl phosphate, a perfluoroalkyl ethylene oxide adduct, a perfluoroalkyl betaine, and a perfluoroalkylamine oxide compound.

The silicone-based surfactant is not particularly limited, and examples thereof include a polysiloxane-based compound and a polyether modified organosiloxane. Examples of a commercially available product of the silicone-based surfactants include BYK-306, BYK-307, BYK-333, BYK-341, BYK-345, BYK-346, BYK-348, BYK-UV3500, BYK-UV3510, BYK-UV3530, and BYK-UV3570 (all trade names, manufactured by BYK-Chemie GmbH).

The content of the surfactant is preferably 0.01% by mass or greater and 5% by mass or less, more preferably 0.1% by mass or greater and 3% by mass or less, and still more preferably 0.3% by mass or greater and 18 by mass or less with respect to the total amount of the ink composition. When the content of the surfactant is set to be in the above-described ranges, the abrasion resistance, the curing properties, the maintainability of flexibility, and the continuous printing stability are further improved, and the initial viscosity tends to be in a more suitable range.

### 1.5. Dispersant

The ink composition of the present embodiment may include a dispersant. The dispersant is not particularly limited, and examples thereof include dispersants that are commonly used to prepare pigment dispersion liquids, such as polymer dispersants. Specific examples thereof include polyoxyalkylene, polyalkylene polyamine, a vinyl-based polymer and a copolymer, an acrylic polymer and a copolymer, polyester, polyamide, polyimide, polyurethane, an amino-based polymer, a silicon-containing polymer, a sulfur-containing polymer, a fluorine-containing polymer, and an epoxy resin. These dispersants are used alone or in combination of two or more kinds thereof.

Examples of a commercially available product of the dispersant include AJISPER series (manufactured by Ajinomoto Fine-Techno Co., Ltd.), Solsperse 32000 and Solsperse 36000 (both trade names, manufactured by Noveon), DISPERBYK Series (manufactured by BYK-Chemie GmbH), and DISPARLON Series (manufactured by Kusumoto Chemicals, Ltd.).

The content of the dispersant is preferably 0.1% by mass or greater and 5% by mass or less, more preferably 0.5% by mass or greater and 38 by mass or less, and still more preferably 18 by mass or greater and 2% by mass or less with respect to the total amount of the ink composition. When the content of the dispersant is set to be in the above-described ranges, the abrasion resistance and the continuous printing stability are further improved, and the initial viscosity tends to be in a more suitable range.

### 1.6. Coloring Material

The ink composition of the present embodiment may contain a coloring material. The coloring material may be any of a pigment or a dye. The pigment is not particularly limited, and examples thereof include an organic pigment and an inorganic pigment. These color materials are used alone or in combination of two or more kinds thereof.

Examples of the organic pigment include an azo pigment such as an azo lake pigment, an insoluble monoazo pigment, an insoluble disazo pigment, a condensed azo pigment, or a chelate azo pigment, a polycyclic pigment such as a phthalocyanine pigment, a quinacridone pigment, a perylene pigment, a perinone pigment, an anthraquinone pigment, a dioxazine pigment, a thioindigo pigment, an isoindolinone pigment, or a quinophthalone pigment, a dye chelate such as a basic dye type chelate or an acid dye type chelate, a nitro pigment, and a nitroso pigment.

Examples of the inorganic pigment include titanium oxide, iron oxide yellow, iron oxide brown, chromium oxide, ultramarine, Prussian blue, molybdenum red, iron oxide black, lead yellow, a composite oxide pigment, and carbon black.

Examples of the carbon black used as a black pigment include C.I. (Colour Index Generic Name) Pigment Black 1, 7, and 11. Examples of a commercially available product of the carbon black include No. 2300, No. 900, MCF88, No. 33, No. 40, No. 45, No. 52, MA7, MA8, MA100, and No. 2200B (all trade names, manufactured by Mitsubishi Chemical Corporation), Raven 5750, 5250, 5000, 3500, 1255, and 700 (all trade names, manufactured by Columbia Carbon Co., Ltd.), Regal 400R, 330R, 660R, Mogul L, Monarch 700, 800, 880, 900, 1000, 1100, 1300, and 1400 (all trade names, manufactured by CABOT Corporation), and Color Black FW1, FW2, FW2V, FW18, FW200, S150, S160, S170, Printex 35, U, V, 140U, Special Black 6, 5, 4A, and 4 (all trade names, manufactured by Degussa-Huls AG). The carbon black may be produced by a known method such as a contact method, a furnace method, or a thermal method.

Examples of a white pigment include C. I. Pigment White 6, 18, and 21.

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, and 180.

Examples of a magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, and C.I. Pigment Violet 19, 23, 32, 33, 36, 38, 43, and 50.

Examples of a cyan pigment include C.I. Pigment Blue 1, 2, 3, 15, 15:1, 15:2, 15:3, 15:34, 15:4, 16, 18, 22, 25, 60, 65, and 66, and C.I. Vat blue 4 and 60.

Examples of pigments other than black, white, yellow, magenta, and cyan include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

The dye is not particularly limited, and examples thereof include an acid dye, a direct dye, a reactive dye, and a basic dye. Specific examples thereof include C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, and 50, C.I. Direct Red 1, 4, 9, 80, 81, 225, and 227, C.I. Direct Blue 1, 2, 15, 71, 86, 87, and 98, C.I. Direct Black 19, 38, 51, 71, and 154, C.I. Reactive Red 14, 32, 55, 79, and 249, and C.I. Reactive Black 3, 4, and 35.

The content of the coloring material is preferably 0.1% by mass or greater and 10% by mass or less, more preferably 1% by mass or greater and 5% by mass or less, and still more preferably 28 by mass or greater and 4% by mass or less with respect to the total amount of the ink composition. When the content of the coloring material is in the above-described ranges, the abrasion resistance and the continuous printing stability are further improved, and the initial viscosity tends to be in a more suitable range.

### 1.7. Other Components

The ink composition may contain, as components other than those described above, for example, various additives such as a chelating agent, a softener, a dissolution assistant, a viscosity adjuster, an ultraviolet absorbing agent, an antioxidant, and a corrosion inhibitor as necessary.

### 2. Method of Preparing Ink Composition

According to a method of preparing an ink composition, the ink composition can be prepared by, for example, mixing each of the components in any order and performing filtration or the like on the mixture as necessary to remove impurities, foreign matter, and the like. As a method of mixing each of the components, a method of sequentially adding each component to a container equipped with a stirring device such as a mechanical stirrer or a magnetic stirrer, and stirring and mixing the mixture is used. Examples of the filtration method include centrifugal filtration and filter filtration.

### 3. Recording Medium

The material of the recording medium used in the present embodiment is not particularly limited, and examples thereof include glass, paper, metals, wood, plastics, and those whose surfaces are processed. Examples of the plastics include polyvinyl chloride, polyethylene terephthalate, polypropylene, polyethylene, polycarbonate, cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, and polyvinyl acetal.

### 4. Recording Method

An ink jet recording method according to the present embodiment includes an adhesion step of ejecting the above-described radiation-curable ink jet ink composition from an ink jet head and making the radiation-curable ink jet ink composition adhere to a shrink film or a soft packaging film, and an irradiation step of irradiating the adhered radiation-curable ink jet ink composition with radiation.

### 5. Recording Device

A recording device of the present embodiment may include an ink jet head including a nozzle that ejects the ink composition to a recording medium and preferably an LED irradiation machine that irradiates the ink composition adhering to the recording medium with ultraviolet light and a carriage on which the ink jet head is mounted.

The ink jet head may be a line type head or a serial type head. In a case of the line type head, the head having a length substantially the same as the size of the recording medium in the width direction is provided. In addition, in a case of the serial type head, the main scanning in the width direction of the recording medium and the sub-scanning in the flow direction intersecting the width direction are repeated, and the radiation-curable ink jet ink composition is ejected in the main scanning.

The content of the polymerization initiator can be increased in the same amount as in the above-described examples, but is, for example, 15% by mass or less with respect to the total amount of the ink.

Since a serial printer having the above-described configuration can irradiate the ink with ultraviolet light a plurality of times, even when an ink composition in which the amount of the polymerization initiator is in the above-described ranges is used, the physical properties of the ink coating film such as the curing properties tend to be more excellent.

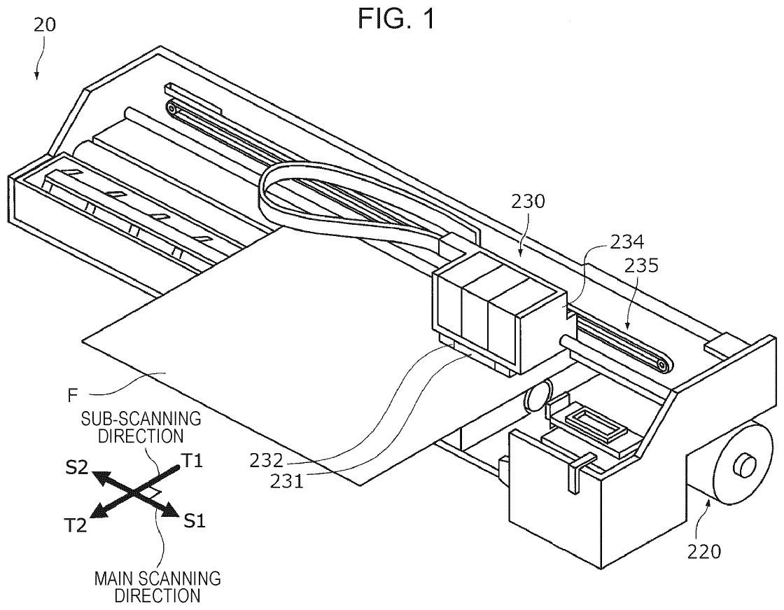

As an example of the recording device, FIG. 1 shows a perspective view of a serial printer. As shown in FIG. 1, a serial printer 20 includes a transport section 220 and a recording section 230. The transport section 220 transports a recording medium F fed to the serial printer to the recording section 230, and discharges the recording medium after recording to the outside of the serial printer. Specifically, the transport section 220 includes each feeding roller and transports the fed recording medium F in a sub-scanning direction T1.

In addition, the recording section 230 includes an ink jet head 231 that ejects an ink composition to the recording medium F sent from the transport section 220, an LED irradiation machine 232 that irradiates the adhered ink composition with ultraviolet light, a carriage 234 on which these members are mounted, and a carriage moving mechanism 235 that moves the carriage 234 in main scanning directions S1 and S2 of the recording medium F.

The ink jet head 231 has a length less than the width of the recording medium F, and repeatedly performs the main scanning in the width direction of the recording medium F and the sub-scanning in the flow direction intersecting the width direction along with the movement of the carriage. The ink jet head 231 ejects the ink composition to the recording medium F when performing the main scanning.

The LED irradiation machine 232 irradiates the ink composition adhering to the recording medium with ultraviolet light. The irradiation with the ultraviolet light may be performed in the same main scanning as the main scanning in which the ink composition is ejected, or may be performed in different main scanning, for example, in the next main scanning after the main scanning in which the ink composition is ejected. The irradiation with the ultraviolet light may be performed a plurality of times in the same main scanning or in a plurality times of different main scanning on the adhered ink composition. In this manner, even when the ink composition having a small amount of the polymerization initiator is used, the physical properties of the ink coating film, such as the curing properties, tend to be more excellent.

Further, although an aspect in which the LED irradiation machine is mounted on the carriage is shown in FIG. 1, the present disclosure is not limited thereto, and an LED irradiation machine that is not mounted on a carriage may be provided.

### Examples

Hereinafter, the present disclosure will be described in more detail with reference to examples and comparative examples. The present disclosure is not limited to the following examples.

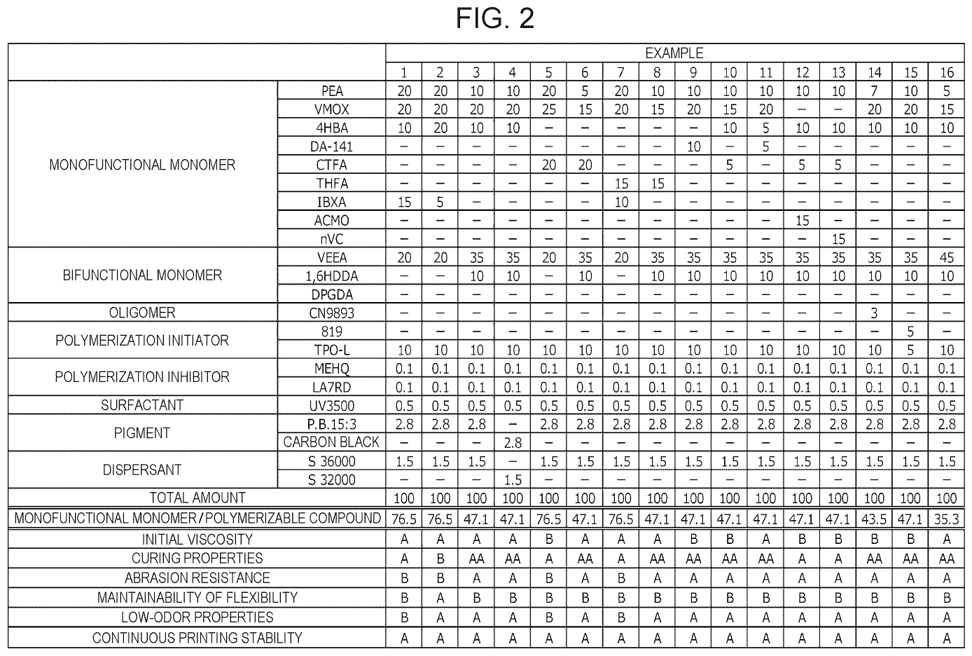

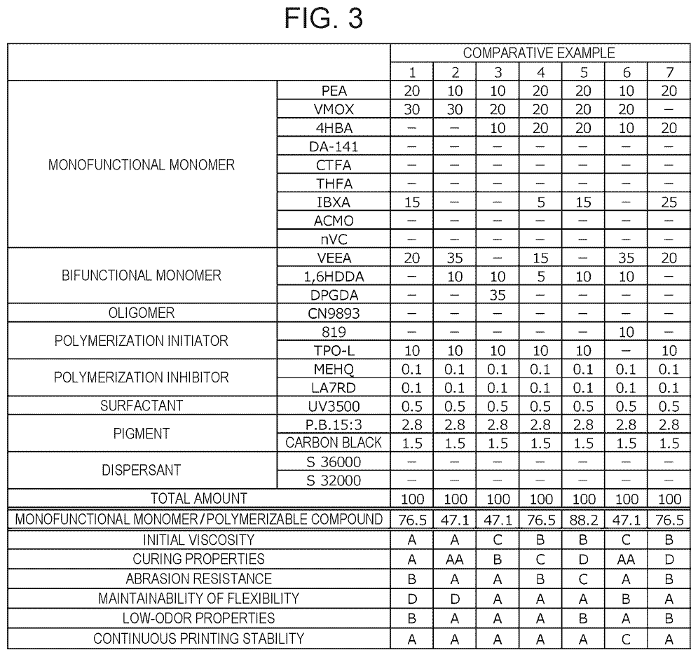

FIGS. 2 and 3 are Tables 1 and 2 listing the configurations of the compositions of each example and each comparative example.

### 1. Preparation of Ink Composition

An ink composition of each example is obtained by adding each component to a tank for a mixture to have the composition listed in Table 1, mixing and stirring the mixture, and further filtering the mixture through a membrane filter. Further, the numerical value of each component shown in each example in the tables is in units of % by mass unless otherwise stated. In addition, in the tables, the numerical value of each content denotes the solid content of the active component in units of % by mass.

The abbreviations used in the ink composition and the details of the product components are as follows.

### Monofunctional Monomer

PEA (phenoxyethyl acrylate)
VMOX (5-methyl-3-vinyl-oxazolidin-2-one).
4HBA (4-hydroxybutyl acrylate)
DA-141 (2-hydroxy-3-phenoxypropyl acrylate)
CTFA (cyclic trimethylolpropane formal acrylate)
THFA (tetrahydrofurfuryl acrylate).
IBXA (isobornyl acrylate)
ACMO (acryloylmorpholine)
nVC (N-vinylcaprolactam)

### Bifunctional Monomer

VEEA (2-(2-vinyloxyethoxy)ethyl acrylate)
1, 6-HDDA (1, 6-hexanediol diacrylate)
DPGDA (dipropylene glycol diacrylate)

### Oligomer

CN9893 (trade name, manufactured by Sartomer Company, Inc., aliphatic urethane acrylate oligomer)

### Polymerization Initiator

Omnirad 819 (trade name, manufactured by IGM Resins B.V., bis(2,4,6-trimethylbenzoyl)phenylphosphine oxide)
Omnirad TPO-L (trade name, manufactured by IGM Resins B.V., ethyl (2,4,6-trimethylbenzoyl)-phenyl phosphinate)

### Polymerization Inhibitor

MEHQ (p-methoxyphenol, manufactured by Kanto Chemical Co., Inc.)
LA-7RD (trade name “ADK STAB LA-7RD”, manufactured by ADEKA Corporation, 4-hydroxy-2,2,6,6-tetramethylpiperidinyl-1-oxyl)

### Surfactant

BYK UV3500 (trade name, manufactured by BYK-Chemie GmbH, silicone-based surfactant)

### Dispersant

S 36000 (trade name “Solsperse 36000”, manufactured by Lubrizol Corporation, polymer dispersant)
S 32000 (trade name “Solsperse 32000”, manufactured by Lubrizol Corporation, polymer dispersant)

### Pigment

P.B. 15:3 (C.I. Pigment Blue 15:3, cyan pigment)
Carbon black (black pigment)

### Water

Pure water

### 2. Evaluation Method

### 2.1. Evaluation of Initial Viscosity

The viscosity of the ink composition of each example is measured using a rotational rheometer MCR-301 (trade name, manufactured by Anton Paar GmbH) in an environment of 20° C. The evaluation criteria are as follows.

### Evaluation Criteria

A: Less than 10 mPa·s
B: 10 to 15 mPa·s
C: 15 to 20 mPa·s
D: 21 mPa·s or greater

### 2.2. Evaluation of Curing Properties

The ink composition of each example in an amount such that the film thickness after curing is 8 μm is coated on PET50A PL Shin (PET film, product name, manufactured by LINTEC Corporation), and the number of times of irradiation with ultraviolet light required until the ink composition is cured is measured. Whether or not the ink composition is cured is determined by rubbing the surface with a cotton swab and determining whether or not the ink adheres to the cotton swab or the ink cured product on the recording medium is scratched. The irradiation with ultraviolet light is performed using an ultraviolet light emitting diode (peak wavelength of 395 nm) so that the irradiation energy per one time is 50 mJ/cm².

### Evaluation Criteria

AA: 1 time
A: 2 times
B: 3 to 5 times
C: 6 times or more

### 2.3. Evaluation of Abrasion Resistance

A modified printer SC-R5050 (trade name, manufactured by Seiko Epson Corporation) is filled with the ink composition of each example, and a solid pattern (ink adhesion amount of 12 mg/inch²) is printed on a recording medium. After the recording medium is allowed to stand at room temperature for 30 minutes, the ink-adhering portion is cut into a rectangular shape with a size of 30×150 mm, and the degree of the ink to be peeled when the surface is rubbed 100 times with an abrasion resistance tester (load of 500 g) using a plain woven fabric wetted with water is visually observed and evaluated according to the following evaluation criteria.

### Evaluation Criteria

A: Rank 1 (no scratch)
B: Rank 2 to 3 (linear scratch)
C: Rank 4 (planar scratch)
D: Rank 5 (peeling)

### 2.4. Evaluation of Maintainability of Flexibility

A polyethylene film (trade name PEN-050501, manufactured by As One Corporation) is coated with the ink composition of each example using a bar coater such that the thickness thereof reaches 10 μm. Next, a coating film is formed by curing the ink composition with an energy of 400 mJ/cm² using a metal halide lamp (manufactured by Eye Graphic Co., Ltd.). A test piece is prepared by cutting out the coating film having a width of 1 cm and a length of 7 cm directly from the polyethylene film on which the coating film is formed in a strip shape. The elongation rate immediately after coating and the elongation rate after standing in an environment of 70° C. after coating for 20 minutes of each test piece are measured using a tensile testing machine TENSILON (trade name, manufactured by ORIENTEC). The elongation rate is calculated by {(length at cracking−length before elongation)/length before elongation×100} at the time of occurrence of cracking when the coating film is stretched at 10 mm/min. A change rate between the elongation rate immediately after the coating and the elongation rate after standing in an environment of 70° C. for 20 minutes after the coating is determined and evaluated as the maintainability of flexibility. The change rate is calculated by {(elongation rate immediately after coating−elongation rate after standing in environment of 70° C. for 20 minutes after coating)/elongation rate immediately after coating×100}. Further, the elongation rate after standing in an environment of 70° C. for 20 minutes corresponds to the elongation rate after standing at room temperature for 10 days.

### Evaluation Criteria

A: Change rate of less than 20%
B: Change rate of less than 40%
C: Change rate of less than 60%
D: Change rate of 60% or greater

### 2.5. Evaluation of Odor Properties

A polyvinyl chloride film JT5829R (trade name, manufactured by MACtac) is coated with the ink composition of each example using a bar coater such that the thickness thereof reaches 10 μm. Next, a coating film is formed by curing the ink composition with an energy of 400 mJ/cm² using a metal halide lamp (manufactured by Eye Graphic Co., Ltd.). Thereafter, the coating film is allowed to stand at room temperature for 1 day, and the odor of the coating film is evaluated by sensory evaluation. Specifically, the odor of the pattern is smelled by 10 panelists, and the odor is evaluated according to the following evaluation criteria in a 6-stage odor intensity display method.

### Evaluation Criteria

A: Odor rank of 2 or lower
B: Odor rank of 3
C: Odor rank of 4
D: Odor rank of 5

### 2.6. Evaluation of Continuous Printing Stability

The ink composition of each example is continuously ejected at a drive frequency of 15 kHz using an ink jet head (360 nozzles) having an ejection nozzle diameter of 20 μm. An inspection is performed every 5 minutes to determine whether or not ink is ejected from all the nozzles, and continuous ejection is performed for up to a total of 50 minutes. The continuous printing stability is evaluated according to the following evaluation criteria.

A: Non-ejecting nozzles are not found for 50 minutes.
B: Non-ejecting nozzles are not found for 20 to 50 minutes.
C: Non-ejecting nozzles are found in 15 minutes or shorter.

### 3. Evaluation Results

As listed in Tables 1 and 2, the radiation-curable ink jet ink composition of the present embodiment has further improved curing properties, abrasion resistance, maintainability of flexibility, low-odor properties, and continuous printing stability, and the initial viscosity tends to be in a more suitable range.

What is claimed is:

1. A radiation-curable ink jet ink composition comprising:
a hydroxyl group-containing monofunctional monomer and/or an ether cyclic structure-containing monofunctional monomer;
a nitrogen-containing heterocyclic structure-containing monofunctional monomer;
a bifunctional monomer; and
a polymerization initiator, wherein
the bifunctional monomer includes a vinyl ether group-containing (meth)acrylate represented by Formula (1),
a content of the vinyl ether group-containing (meth)acrylate is 20% by mass or greater with respect to a total amount of the ink composition, and
the polymerization initiator includes ethyl phenyl(2,4,6-trimethylbenzoyl)phosphinate,
H₂C═CR¹—CO—OR²O—CH═CH—R³ (1)
in the formula, R¹ represents a hydrogen atom or a methyl group, R² represents a divalent organic residue having 2 to 20 carbon atoms, and R³ represents a hydrogen atom or a monovalent organic residue having 1 to 11 carbon atoms.

2. The radiation-curable ink jet ink composition according to claim 1, wherein
the nitrogen-containing heterocyclic structure-containing monofunctional monomer has one or more selected from the group consisting of an oxazoline structure, a morpholine structure, and an ε-caprolactam structure.

3. The radiation-curable ink jet ink composition according to claim 1, wherein
the hydroxyl group-containing monofunctional monomer includes 4-hydroxybutyl (meth)acrylate.

4. The radiation-curable ink jet ink composition according to claim 1, wherein
the ether cyclic structure-containing monofunctional monomer includes cyclic trimethylolpropane formal (meth)acrylate and/or tetrahydrofurfuryl (meth)acrylate.

5. The radiation-curable ink jet ink composition according to claim 1, wherein
the content of the vinyl ether group-containing (meth)acrylate is 50% by mass or less with respect to the total amount of the ink composition.

6. The radiation-curable ink jet ink composition according to claim 1, wherein
the bifunctional monomer further includes 1,6-hexanediol di(meth)acrylate and/or dipropylene glycol di(meth)acrylate.

7. The radiation-curable ink jet ink composition according to claim 1, wherein
the polymerization initiator further includes bis(2,4,6-trimethylbenzoyl)phenylphosphine oxide.

8. The radiation-curable ink jet ink composition according to claim 1, further comprising:
an aromatic ring-containing monofunctional monomer.

9. The radiation-curable ink jet ink composition according to claim 1, wherein
a content of the ethyl phenyl(2,4,6-trimethylbenzoyl)phosphinate is 1% to 15% by mass with respect to the total amount of the ink composition.

10. A recording device comprising:
an ink jet head that ejects the radiation-curable ink jet ink composition according to claim 1.

11. A recording device comprising:
an ink jet head that ejects the radiation-curable ink jet ink composition according to claim 1 to a recording medium;
an LED irradiation machine that irradiates the ink composition adhering to the recording medium with ultraviolet light; and
a carriage on which the ink jet head is mounted, wherein
the ink jet head repeatedly performs main scanning in a width direction of the recording medium and sub-scanning in a flow direction intersecting the width direction, and ejects the radiation-curable ink jet ink composition in the main scanning, and
a content of the polymerization initiator is 15% by mass or less with respect to the total amount of the ink composition.
